(19) United States
(12) Patent Application Publication
(10) Pub. No.: US 2003/0001539 A1
(43) Pub. Date: Jan. 2, 2003

(54) Analog electronic clock

(76) Inventor: Teruaki Hanzaki, Chiba-shi (JP)

Correspondence Address: ADAMS & WILKS, ATTORNEYS AND COUNSELORS AT LAW, 50 BROADWAY, 31st FLOOR, NEW YORK, NY, 10004, US

(21) Appl. No.: 10/164,051

(22) Filed: Jun. 6, 2002

(30) Foreign Application Priority Data
Jun. 20, 2001 (JP) 2001-186134

(51) Int. Cl. H02P 5/28

(52) U.S. Cl. 318/811

(57) ABSTRACT

It is an object to control the rotation of a motor for driving clock hands more reliably and to prevent abnormal wear and breakage of components due to an overload. When a rotation detecting circuit detects that a motor has not been rotated by a normal driving pulse, a control circuit controls the rotation of the motor with a corrective driving pulse having a pulse width greater than that of the normal driving pulse. When the rotation detecting circuit detects that the motor has not been rotated even by the corrective driving pulse, it stops controlling the rotation of the motor and notifies the fact that the movement of the hands of the clock has stopped with a notifying device.

### BACKGROUND OF THE INVENTION

1. Field of the Invention

The present invention relates to an analog electronic clock in which the rotation of a motor for driving clock hands is controlled based on a driving pulse supplied from motor control means and which displays time with the clock hands that are driven for rotation by the motor.

2. Description of the Prior Art

Analog electronic clocks have been conventionally used including analog electronic wrist watches and analog electronic clocks in which the rotation of a motor for driving clock hands is controlled based on a driving pulse supplied from motor control means and which displays time with the clock hands that are driven for rotation by the motor.

In general, a step motor is used as the motor; a normal driving pulse having small effective power and having a predetermined width is supplied to a motor driving circuit from the control means; and the motor driving circuit drives the motor with a pulse having the same width as that of the supplied driving pulse.

In some cases, the rotation of the motor cannot be controlled by the normal driving pulse because of a drop in the power supply voltage, aging of the motor control means or a motor driving mechanism, and so on. In order to control the rotation of the motor with higher reliability even in such a case, the rotation of the motor is detected after the normal driving pulse is supplied to the motor and, when no rotation is detected, a corrective driving pulse having effective power greater than that of the normal driving pulse (for example, a width greater than that of the normal driving pulse) is supplied to the motor to rotate the motor forcibly (for example, see Japanese Patent Publication No. 18148/1988 and Japanese Patent Laid-Open No. 9865/2000).

However, since the motor is forcibly rotated by the corrective driving pulse, a gear train for driving the motor is overloaded, which has resulted in the risk of abnormal wear and breakage of components.

### SUMMARY OF THE INVENTION

It is an object of the invention to control the rotation of a motor for driving clock hands more reliably and to prevent abnormal wear and breakage of components because of an overload.

According to the invention, there is provided an analog electronic clock in which the rotation of a motor for driving clock hands is controlled based on a driving pulse supplied from motor control means and which displays time with the clock hands that are driven for rotation by the motor, characterized in that the motor control means has normal driving pulse generation means for generating a normal driving pulse having a predetermined pulse width, corrective driving pulse generation means for generating a corrective driving pulse having energy higher than that of the normal driving pulse and rotation detecting means for detecting the rotation of the motor and in that the rotation of the motor is controlled by the corrective driving pulse when the rotation detecting means detects that the motor has not been rotated by the normal driving pulse and the rotation control of the motor is stopped when the rotation detecting means detects that the motor has not been rotated by the corrective driving pulse. The rotation of the motor is controlled by the corrective driving pulse when the rotation detecting means detects that the motor has not been rotated by the normal driving pulse, and the rotation of the motor is stopped when the rotation detecting means detects that the motor has not been rotated by the corrective driving pulse.

The motor control means has rotation detection driving pulse generation means for generating a driving pulse for detecting rotation, and the motor is driven by the driving pulse for detecting rotation after the rotation of the motor is controlled by the corrective driving pulse to detect whether the motor has rotated or not with the rotation detecting means.

The corrective driving pulse may be a driving pulse having a width greater than that of the normal driving pulse.

A configuration may be employed in which there is provided notifying means for notifying the fact that the movement of the hands has stopped when the motor control means has stopped controlling the rotation of the motor.

### BRIEF DESCRIPTION OF THE SEVERAL VIEWS OF THE DRAWINGS

A preferred form of the present invention is illustrated in the accompanying drawings in which:

FIG. 1 is a block diagram of an analog electronic clock according to a mode for carrying out the invention;

FIG. 2 are timing charts of the analog electronic clock according to the mode for carrying out the invention;

FIG. 3 is an illustration of a motor driving circuit and a rotation detecting circuit used in the mode for carrying out the invention;

FIG. 4 is an illustration of the motor driving circuit and the rotation detecting circuit used in the mode for carrying out the invention; and

FIG. 5 is a waveform diagram for explaining a rotation detecting operation in the mode for carrying out the invention.

### DETAILED DESCRIPTION OF THE PREFERRED EMBODIMENTS

A mode for carrying out the invention will now be described in detail with reference to the drawings.

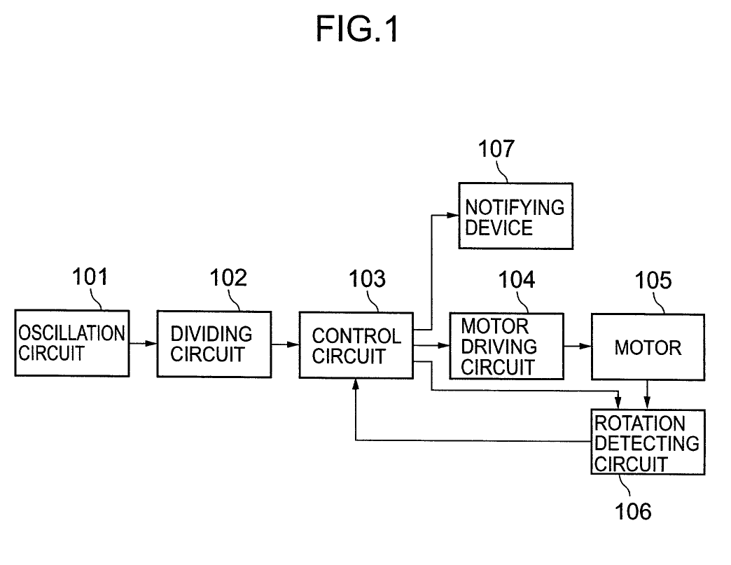

FIG. 1 is a block diagram of an analog electronic clock according to a mode for carrying out the invention, and it shows an example of an analog electronic wrist watch.

In FIG. 1, an oscillation circuit 101 is connected to an input section of a control circuit 103 through a dividing circuit 102. A first output section of the control circuit 103 is connected to a step motor 105 for driving clock hands through a motor driving circuit 104. A second output section of the control circuit 103 is connected to a control input section of a rotation detecting circuit 106. A third output section of the control circuit 103 is connected to a notifying device 107 for notifying of the stoppage of the movement of the hands. The notifying device 107 constitutes the notifying means, and a display device which visually notifies of the stoppage of the movement of the hands or a buzzer or the like which acoustically notifies of the same may be used. A rotation detecting circuit 106 for detecting whether the motor 105 has rotated or not is connected between the motor 105 and the control circuit 103. The rotation detecting circuit 106 constitutes the rotation detecting means.

The dividing circuit 102 divides the frequency of a reference clock signal from the oscillation circuit 101 and outputs it to the control circuit 103. The control circuit 103 receives the signal from the dividing circuit 102 and outputs a driving pulse to the motor driving circuit 104. A normal driving pulse which is a driving pulse having small effective energy and a predetermined pulse width and a corrective driving pulse which is a driving pulse having effective energy greater than that of the normal driving pulse are prepared as the driving pulse, and the control circuit 103 selectively outputs the normal driving pulse and corrective driving pulse to the motor driving circuit 104 in accordance with a detection signal from the rotation detecting circuit 106. The control circuit 103 constitutes the normal driving pulse generating means for generating the normal driving pulse and the corrective driving pulse generating means for generating the corrective driving pulse.

The control circuit 103 supplies the rotation detecting circuit 106 with a control pulse for detecting rotation required for the rotation detecting circuit 106 to detect the rotation of the motor 105. The control circuit 103 constitutes rotation detection control pulse generating means for generating a control pulse for detecting rotation.

The motor driving circuit 104 is a motor driving circuit having two P-channel MOS transistors and two N-channel MOS transistors and having a configuration including a circuit in which a coil of the motor 105 is connected between common sources.

The oscillation circuit 101, the dividing circuit 102, the control circuit 103 and the rotation detecting circuit 106 constitute the motor control means.

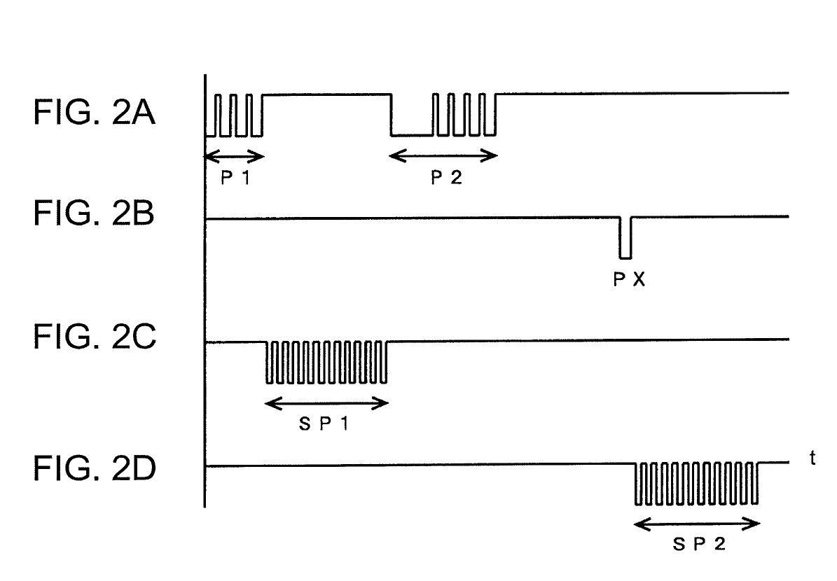

FIGS. 2 are timing charts in the present mode for carrying out the invention. It shows an example in which it is detected that the motor 105 is not rotating as a result of detection of the rotation of the motor 105 performed by the rotation detecting circuit 106 in response to a control pulse SP1 for detecting rotation after the motor 105 is rotated by a normal driving pulse P1. As will be detailed later, when the rotation detecting circuit 106 detects that the motor 105 is not rotating, the motor driving circuit 104 controls the rotation of the motor 105 based on a corrective driving pulse P2 and thereafter controls the rotation of the motor 105 with a driving pulse Px for detecting rotation, and the rotation detecting circuit 106 operates to detect the rotation of the motor 105 in response to a control pulse SP2 for detecting rotation.

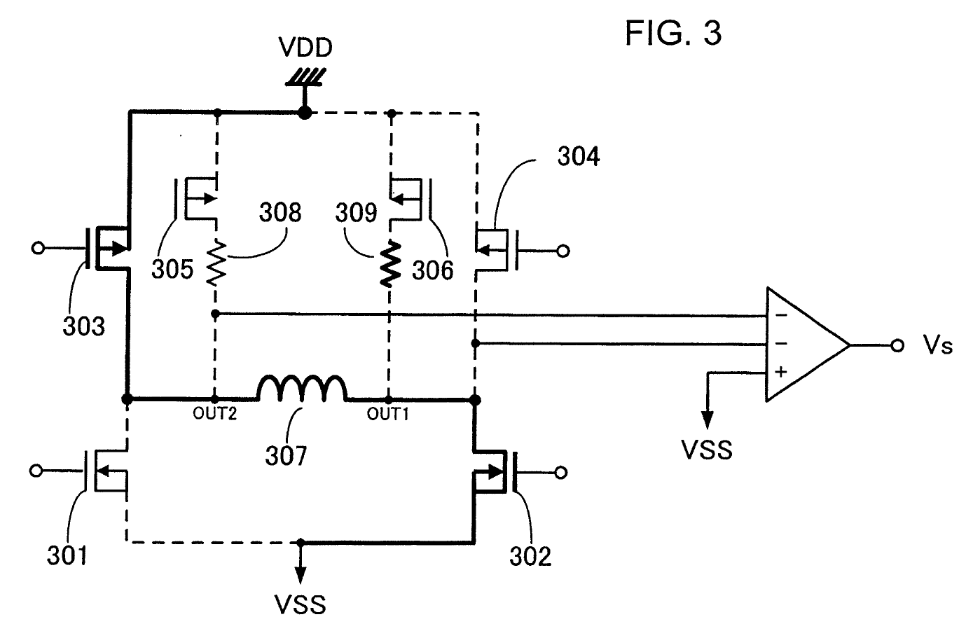

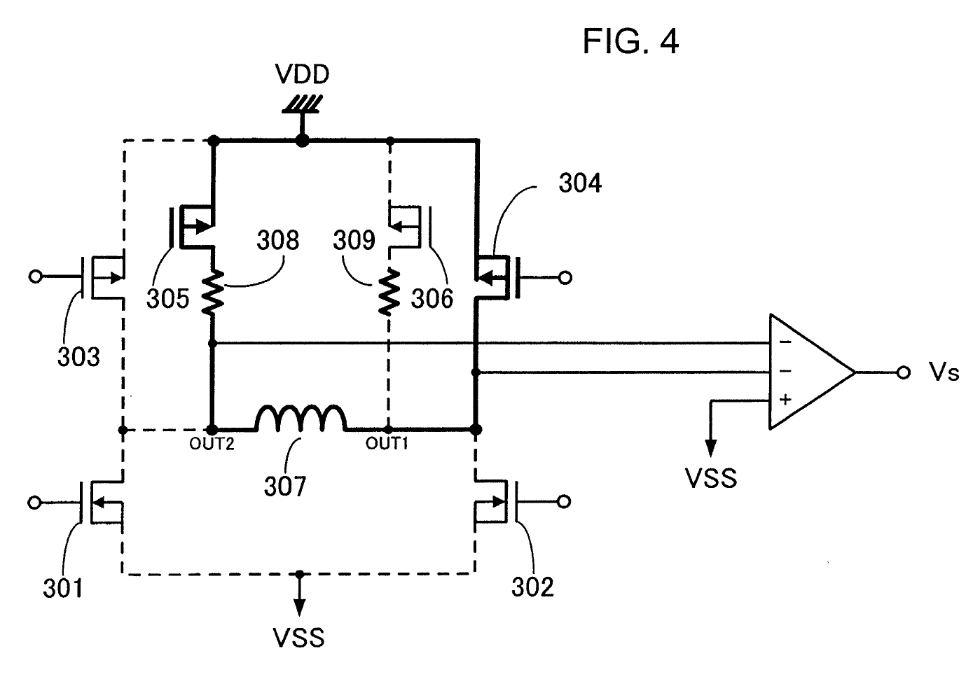

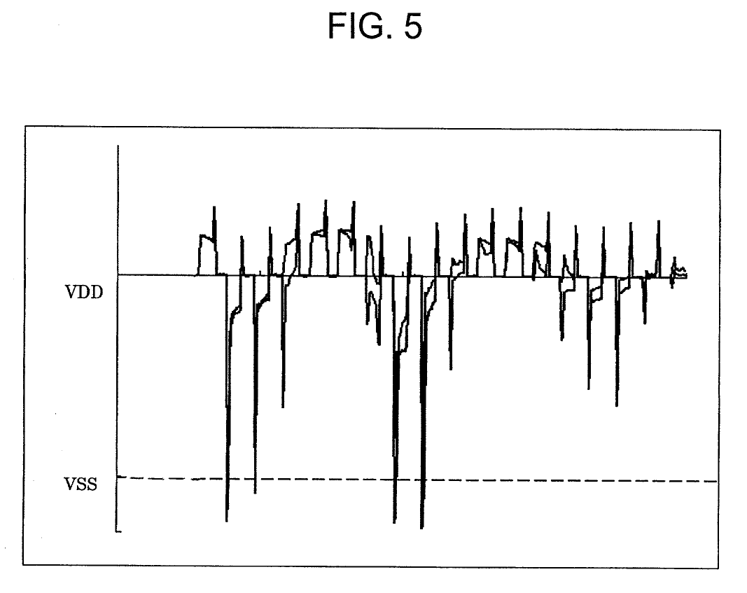

FIG. 3 and FIG. 4 are circuit diagrams showing the motor driving circuit 104 and the rotation detecting circuit 106; FIG. 3 is an illustration of the control of the rotation of the motor 105; and FIG. 4 is an illustration of the detection of the rotation of the motor 105. FIG. 5 is a waveform diagram of a signal obtained when the rotation of the motor 105 is detected.

In FIG. 3 and FIG. 4, P-channel MOS transistors 301, 302 and N-channel MOS transistors 303, 304 are transistors included in the motor driving circuit 104, and a coil 307 of the motor 105 is connected between a point where sources of the transistor 301 and transistor 303 are connected and a point where sources of the transistor 302 and transistor 304 are connected.

N-channel transistors 305, 306, a resistor 308 for detecting rotation that is series-connected to the transistor 305, a resistor 309 for detecting rotation that is series-connected to the transistor 306 and a comparator 310 are included in the rotation detecting circuit 106.

An operation of the analog electronic clock according to the present mode for carrying out the invention will now be described with reference to FIGS. 1 to 5.

First, in a motor driving period, the normal driving pulse P1 in FIG. 2A is supplied from the control circuit 103 to the motor driving circuit 104 and, as a result, the motor driving circuit 104 controls the rotation of the motor 105. In this case, as shown in FIG. 3, the transistors 302, 303 of the motor driving circuit 104 are controlled to be in an on state, and a driving current consequently flows through the coil 307 to rotate the motor 105.

At the next driving of the motor, although not shown, when the next normal driving pulse P1 is supplied from the control circuit 103 to the motor driving circuit 104, the transistors 301, 304 are controlled to be in the on state, and a driving current in the direction opposite to that of the driving current flows through the coil 307 to rotate the motor 105. Thereafter, the operation is repeated to rotate the motor 105.

A rotation detecting period is provided immediately after each motor driving period to detect whether the motor 105 has rotated or not.

In the rotation detecting period, the control pulse SP1 for detecting rotation in FIG. 2C is supplied from the control circuit 103 to the rotation detecting circuit 106. The rotation detecting circuit 106 controls the transistors 304, 305 to put them in the on state as shown in FIG. 4 in response to the control pulse SP1 for detecting rotation, and controls the transistor 303 on/off in predetermined cycles with the transistors 304, 305 in the on state.

At this time, a detection voltage that develops at the resistor 308 for detecting rotation is taken out from a terminal OUT2. A signal having a waveform as shown in FIG. 5 is obtained as the detection voltage. When the detection voltage is equal to or lower than a predetermined threshold (Vss in the present mode for carrying out the invention), i.e., when the motor 105 is rotating, a rotation detection signal Vs at a high level indicating that the motor 105 is rotating is output from a comparator 310. When the motor 105 is not rotating, i.e., when the detection voltage does not exceed the threshold, a rotation detection signal Vs at a low level indicating that the motor 105 is not rotating is output from the comparator 310.

Although not shown, in the period for rotation detection performed after the end of the next motor driving period, the rotation detecting circuit 106 controls the transistors 303, 306 to put them in the on state in response to the next control pulse SP1 for detecting rotation and controls the transistor 304 on/off in predetermined cycles in this state. At this time, a detection voltage that develops at the resistor 309 for detecting rotation is taken out from a terminal OUT1. When the detection voltage is equal to or lower than the predetermined threshold, i.e., when the motor 105 is rotating, a rotation detection signal Vs at the high level indicating that the motor 105 has rotated is output from the comparator 310. When the motor 105 is not rotating, i.e., when the detection voltage does not exceed the threshold, a rotation detection signal Vs at the low level indicating that the motor 105 has not rotated is output from the comparator 310.

In each of the rotation detecting periods, the control circuit 103 receives the rotation detection signal Vs from the rotation detecting circuit 106 and judges whether the motor 105 has rotated or not.

A description will now be made on an operation in the case in which the motor 105 has not been rotated by the normal driving pulse P1.

When the motor 105 has not been rotated by the normal driving pulse P1, a rotation detection signal Vs indicating that the motor 105 has not rotated is input from the rotation detecting circuit 106 to the control circuit 103. Upon receipt of the rotation detection signal Vs indicating that there is no rotation, the control circuit 103 judges that the motor 105 has not rotated and supplies a corrective driving pulse P2 having a width greater than that of the normal driving pulse as shown in FIG. 2A to the motor driving circuit 104. The motor driving circuit 104 controls the rotation of the motor 105 with the corrective driving pulse P2.

After the control circuit 103 finishes driving the motor 105 with the corrective driving pulse, it supplies a driving pulse Px having a pulse width smaller than that of the normal driving pulse P1 (FIG. 2B) to the motor driving circuit 104 and thereafter outputs a control pulse SP2 for detecting rotation (FIG. 2D) to the rotation detecting circuit 106.

The rotation detecting circuit 106 is a type which detects a voltage induced by the rotation and vibration of a rotor (not shown) included in the motor 105, and the induced voltage is not generated and rotation can not be detected in the case that the vibration of the rotor has already stopped when the corrective driving pulse P2 ends because the corrective driving pulse P2 has a great pulse width. Therefore, the driving pulse Px for detecting rotation is supplied to the motor driving circuit 104 immediately after the end of the corrective driving pulse P2, to vibrate the rotor of the motor 105, and the rotation detecting circuit 105 detects whether there is rotation or not. Therefore, the driving pulse Px for detecting rotation is formed with a pulse width smaller than that of the normal driving pulse because it is required only to vibrate the rotor of the motor 105 and is not required to rotate the motor 105.

The motor driving circuit 104 drives the motor 105 with the driving pulse Px for detecting rotation. The rotation detecting circuit 106 detects whether the motor 105 has rotated or not in response to the control pulse SP2 for detecting rotation.

When the motor 105 has been rotated by the corrective driving pulse, in the same manner as described above, a rotation detection signal Vs at the high level indicating that the motor 105 has rotated is output from the rotation detecting circuit 106 to the control circuit 103. When the motor 105 has not been rotated by the corrective driving pulse, in the same manner as described above, a rotation detection signal Vs at the low level indicating that the motor 105 has not rotated is output from the rotation detecting circuit 106 to the control circuit 103.

Upon receipt of the rotation detection signal Vs from the rotation detecting circuit 106 indicating that the motor 105 has rotated, the control circuit 103 thereafter drives the motor 105 with the driving pulse returned to the normal driving pulse P1. On the other hand, upon receipt of the rotation detection signal Vs from the rotation detecting circuit 106 indicating that the motor 105 has not rotated even when driven by the corrective driving pulse, the control circuit 103 stops controlling the rotation of the motor 105 to stop the operation of moving the hands and notifies of the fact that the movement of the hands has been stopped using the notifying device 107.

As described above, the analog electronic clock according to the present mode for carrying out the invention is particularly an analog electronic clock in which the rotation of a motor 105 for driving clock hands is controlled based on a driving pulse supplied from motor control means and which displays time with the clock hands that are driven for rotation by the motor 105, characterized in that the motor control means has normal driving pulse generation means for generating a normal driving pulse P1 having a predetermined pulse width, corrective driving pulse generation means for generating a corrective driving pulse P2 having energy higher than that of the normal driving pulse P1 and a rotation detecting circuit 106 for detecting the rotation of the motor 105 and in that the rotation of the motor 105 is controlled by the corrective driving pulse P2 when the rotation detecting circuit 106 detects that the motor 105 has not been rotated by the normal driving pulse P1, and the rotation control of the motor 105 is stopped when the rotation detecting circuit 106 detects that the motor 105 has not been rotated by the corrective driving pulse P2.

It is therefore possible to control the rotation of the motor 105 more reliably and to prevent abnormal wear and breakage of components due to an overload.

There is provided a notifying device 107 for notifying the fact that the motor 105 has stopped, and the notifying device 107 is configured such that it notifies the fact that the movement of the hands has stopped when the motor control means has stopped controlling the rotation of the motor 105. It is therefore possible to quickly notify a user of the fact that the movement of the hands of the clock has stopped.

The motor control means has rotation detection driving pulse generation means for generating a driving pulse Px for detecting rotation and has a configuration in which it controls the rotation of the motor 105 with the corrective driving pulse P2, thereafter controls the rotation of the motor 105 with the driving pulse Px for detecting rotation and detects whether the motor 105 has rotated or not with the rotation detecting circuit 106. It is therefore possible to detect the rotation of the motor reliably even when the corrective driving pulse P2 is a pulse having a very large width.

A driving pulse having a pulse width greater than that of the normal driving pulse P1 is used as the corrective driving pulse P2 in the present mode for carrying out the invention, but it is possible to use a driving pulse having a great wave height value.

According to the present invention, it is possible to control the rotation of a motor for driving clock hands more reliably and to prevent abnormal wear and breakage of components due to an overload.

What is claimed is:

1. An analog electronic clock comprising:
motor control means for suppliing a driving pulse to control the rotation of a motor for driving clock hands,
wherein the clock hands display time with driving for rotation by the motor,
the motor control means has normal driving pulse generation means for generating a normal driving pulse having a predetermined pulse width, corrective driving pulse generation means for generating a corrective driving pulse having energy higher than that of the normal driving pulse and rotation detecting means for detecting the rotation of the motor and in that the rotation of the motor is controlled by the corrective driving pulse when the rotation detecting means detects that the motor has not been rotated by the normal driving pulse and the rotation control of the motor is stopped when the rotation detecting means detects that the motor has not been rotated by the corrective driving pulse.

2. An analog electronic clock according to claim 1, wherein the motor control means has rotation detection driving pulse generation means for generating a driving pulse for detecting rotation and in that the motor is driven by the driving pulse for detecting rotation after the rotation of the motor is controlled by the corrective driving pulse to detect whether the motor has rotated or not with the rotation detecting means.

3. An analog electronic clock according to claim 1, wherein the corrective driving pulse is a driving pulse having a width greater than that of the normal driving pulse.

4. An analog electronic clock according to claim 1 further comprising:
notifying means for notifying the fact that the movement of the hands has stopped when the motor control means has stopped controlling the rotation of the motor.
